(19) United States
(12) Patent Application Publication
(10) Pub. No.: US 2023/0334809 A1
(43) Pub. Date: Oct. 19, 2023

(54) THREE-DIMENSIONAL DATA SCALE SETTING METHOD AND THREE-DIMENSIONAL DATA SCALE SETTING PROGRAM

(71) Applicants: AB. do. Corp., Nagano (JP); SHINSHU UNIVERSITY, Nagano (JP)

(72) Inventors: Katsuhiko AOKI, Nagano (JP); Kazuyuki TAKEMAE, Nagano (JP); Kiyoshi TANAKA, Nagano (JP); Jaime Alberto SANDOVAL GALVEZ, Nagano (JP); Shunya CHIKUNI, Nagano (JP); Munetoshi IWAKIRI, Kanagawa (JP)

(21) Appl. No.: 18/245,367

(22) PCT Filed: Sep. 18, 2020
(86) PCT No.: PCT/JP2020/035377

§ 371 Date: Mar. 15, 2023

(51) Int. Cl. G06T 19/20; G06T 7/50; G01S 17/06

(52) U.S. Cl. CPC G06T 19/20; G06T 7/50; G01S 17/06; G06T 2219/2016

(57) ABSTRACT

To set a scale for three dimensional data composed from point cloud data: a plurality of reference objects (22) of sizes and shapes known in advance are disposed around an object (20) under measurement; image data or position data obtained by imaging the object (20) under measurement together with the plurality of reference objects (22) from various angles is input to a computer (30); the known sizes and shapes of the reference objects (22) are input to the computer (30); and the computer (30) acquires point cloud data for the object (20) under measurement and each reference object (22) from a plurality of pieces of the image data or a plurality of pieces of the position data, determines, as reference objects, objects in the point cloud data having sizes and shapes within prescribed error ranges with respect to the sizes and shapes input for the reference objects (22), and sets the overall scale of the point cloud data by extending/contracting and/or twisting the point cloud data such that each of the determined reference objects has the input size and shape.

### TECHNICAL FIELD

The present invention relates to a method and a program for providing an accurate three-dimensional scale to three-dimensional data that is generated from a plurality of photographs or position data obtained by laser scanning.

### BACKGROUND ART

Three-dimensional data is generated by a known method as disclosed in PTL 1. This method involves obtaining point cloud data based on a plurality of photographs that are taken from positions surrounding a measurement target.

In an image processing method in PTL 1, point cloud data is extracted from data of photographic images taken by a plurality of cameras. In this process, parameters such as positions, attitudes, and focal distances of the cameras are obtained as camera parameters, and distances from viewpoints are set based on these camera parameters to generate point cloud data.

### CITATION LIST

### Patent Literature

PTL 1: JP-A-2018-36897

### SUMMARY OF INVENTION

### Technical Problem

Unfortunately, the method as disclosed in PTL 1 (JP-A-2018-36897) provides point cloud data but does not provide an accurate scale thereto.

In one example, in PTL 1, a distance image (depth map) showing a distribution of distance between an observation viewpoint and a target is created. In this method, only a distance from a predetermined observation viewpoint to point cloud data is set, and the whole point cloud data that is obtained is not three-dimensionally set.

Thus, three-dimensional data having an accurate scale is not obtained.

### Solution to Problem

The present invention has been accomplished in order to solve the above issue, and an object of the present invention is to provide a method and a program for providing an accurate three-dimensional scale to point cloud data that is generated based on image data obtained by a digital camera or position data obtained by a laser scanner.

The present invention provides a three-dimensional data scale setting method that is a method for providing a scale to three-dimensional data composed of point cloud data. The method is characterized by including: arranging a plurality of reference objects having known dimensions and known shapes, around a measurement target; inputting to a computer, image data obtained by photographing the measurement target and the plurality of reference objects from various angles with a use of a digital camera, or position data obtained by scanning the measurement target and the plurality of reference objects from various angles with a use of a laser scanner; and inputting the known dimension and the known shape of each of the reference objects, to the computer. The computer is configured to: obtain point cloud data containing the measurement target and each of the reference objects, from a plurality of pieces of the image data or a plurality of pieces of the position data; recognize an object with a dimension and a shape within predetermined error ranges based on the input dimension and the input shape of each of the reference objects, as the reference object, in the point cloud data; and set a scale of the point cloud data as a whole by expanding and contracting, and/or twisting, the point cloud data, so that each of the recognized reference objects has the input dimension and the input shape. In this method, the plurality of reference objects having known dimensions and known shapes are arranged around the measurement target, and photographs of the measurement target and the reference objects are obtained. Then, the point cloud data is optimized so that the dimensions and the shapes of the plurality of reference objects will be the known dimensions and the known shapes. Using this method provides an accurate scale to the whole point cloud data, resulting in generation of three-dimensional data having an accurate scale.

The three-dimensional data scale setting method may be characterized in that the reference object is a cube or a rectangular prism. With this structure, the reference objects are relatively easily found from the point cloud data.

The three-dimensional data scale setting method may be characterized in that the number of the reference objects arranged around the measurement target is at least two, and the measurement target is positioned on a straight line connecting the reference objects.

With this method, optimizing a space so that all of the reference objects will have the known dimensions and the known shapes reliably provides an accurate scale also to the measurement target.

The three-dimensional data scale setting method may be characterized in that each of the reference objects arranged so as to surround the measurement target is disposed at a position in or below a plane in which the measurement target is set up, and an upper reference object having a known dimension and a known shape is set up on an upper side of the measurement target.

With this structure, the point cloud data is optimized so that the reference objects and the upper reference object will have correct dimensions and shapes, whereby a more accurate scale is provided also in the height direction of the point cloud data of the measurement target.

The present invention also provides a three-dimensional data scale setting method that is a method for providing a scale to three-dimensional data composed of point cloud data. The method is characterized by including: inputting to a computer, image data obtained by photographing a measurement target and a plurality of structures from various angles with a use of a digital camera, or position data obtained by scanning the measurement target and the plurality of structures from various angles with a use of a laser scanner, the structures having known dimensions and known shapes and being provided around the measurement target; and inputting the known dimension and the known shape of each of the structures, to the computer. The computer is configured to: obtain point cloud data containing the measurement target and each of the structures, from a plurality of pieces of the image data or a plurality of pieces of the position data; recognize an object with a dimension and a shape within predetermined error ranges based on the input dimension and the input shape of each of the structures, as the structure, in the point cloud data; and set a scale of the point cloud data as a whole by expanding and contracting, and/or twisting, the point cloud data, so that each of the recognized structures has the input dimension and the input shape.

In this method, in the state in which a plurality of reference objects having known dimensions and known shapes are not arranged around a measurement target, but structures having known dimensions and known shapes are present around the measurement target, point cloud data is optimized so that the dimensions and the shapes of the structures will be the known dimensions and the known shapes. Using this method provides an accurate scale to the whole point cloud data, resulting in generation of three-dimensional data having an accurate scale.

The present invention also provides a three-dimensional data scale setting method being a method for providing a scale to three-dimensional data composed of point cloud data. The method is characterized by including: arranging a plurality of planar reference objects around a measurement target, the planar reference object having two reference points that are shown on the same surface and have a known length therebetween; inputting to a computer, image data obtained by photographing the measurement target and the plurality of planar reference objects from various angles with a use of a digital camera, or position data obtained by scanning the measurement target and the plurality of planar reference objects from various angles with a use of a laser scanner; and inputting the length between the reference points on each of the planar reference objects, to the computer. The computer is configured to: obtain point cloud data containing the measurement target and each of the planar reference objects, from a plurality of pieces of the image data or a plurality of pieces of the position data; and set a scale of the point cloud data as a whole by expanding and contracting, and/or twisting, the point cloud data, so that the length between the reference points shown on each of the planar reference objects in the point cloud data has the input length.

This method eliminates the need for recognizing the reference objects having known dimensions and known shapes, in the point cloud data, and it involves recognizing only the reference points. Thus, it is not necessary to perform a process of recognizing an object having a dimension and a shape within predetermined error ranges based on the input dimension and the input shape, as the reference object. As a result, a scale is more quickly set to the point cloud data.

### Advantageous Effects of Invention

The three-dimensional data scale setting method and program of the present invention enable providing an accurate scale to point cloud data without using large-scale equipment.

### BRIEF DESCRIPTION OF DRAWINGS

FIG. 1 is an explanatory diagram of arrangement of a measurement target and a plurality of reference objects in photographing the measurement target.

FIG. 2 is a plane view of the explanatory diagram of the arrangement in FIG. 1.

FIG. 3 is a block diagram illustrating a configuration of a computer.

FIG. 4 is a flowchart of a point cloud data generating program.

FIG. 5 is a flowchart of a three-dimensional data scale setting program.

FIG. 6 is an explanatory diagram of a plane estimation function.

FIG. 7 is an explanatory diagram illustrating differences of point cloud data in which one reference object is provided with an accurate scale, from point cloud data that is provided with an accurate scale.

FIG. 8 is an explanatory diagram illustrating a state in which the whole point cloud data is provided with an accurate scale from the state shown in FIG. 7.

FIG. 9 is an explanatory diagram of arrangement of a plurality of reference objects that are arranged so as to surround the whole measurement target, including upper and lower sides of the measurement target.

FIG. 10 is a plane view of the explanatory diagram of the arrangement in

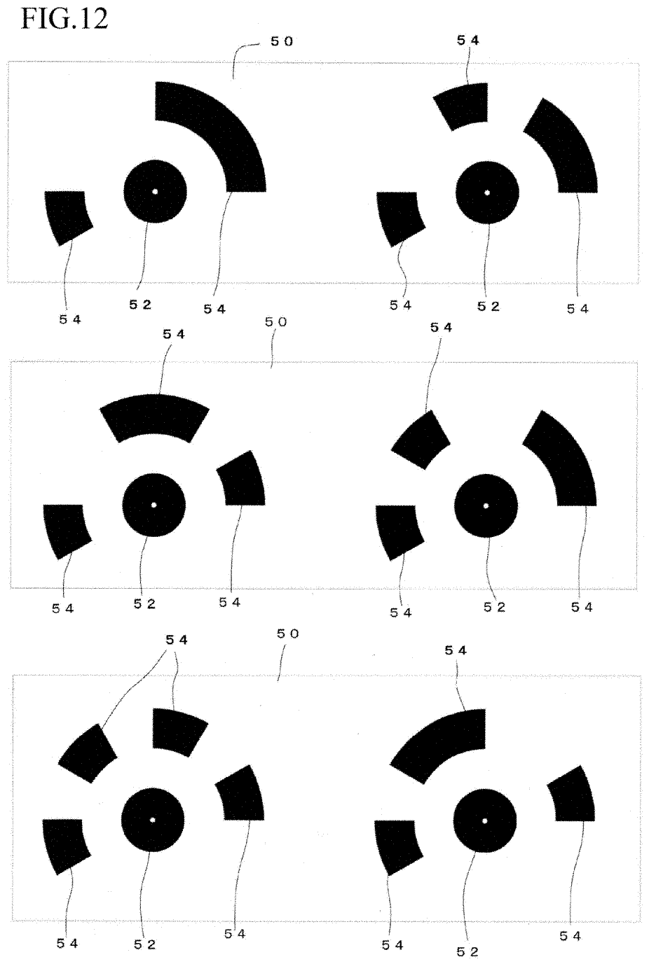

FIG. 9.

FIG. 11 is an explanatory diagram of arrangement of an embodiment in which indoor fittings are set as reference objects.

FIG. 12 is an explanatory diagram of planar reference objects.

FIG. 13 is an explanatory diagram of arrangement of a plurality of planar reference objects around a measurement target.

### DESCRIPTION OF EMBODIMENTS

The following describes embodiments of obtaining point cloud data based on image data that is obtained by photographing a measurement target with the use of a digital camera. Note that point cloud data may also be referred to as “three-dimensional data” in this specification.

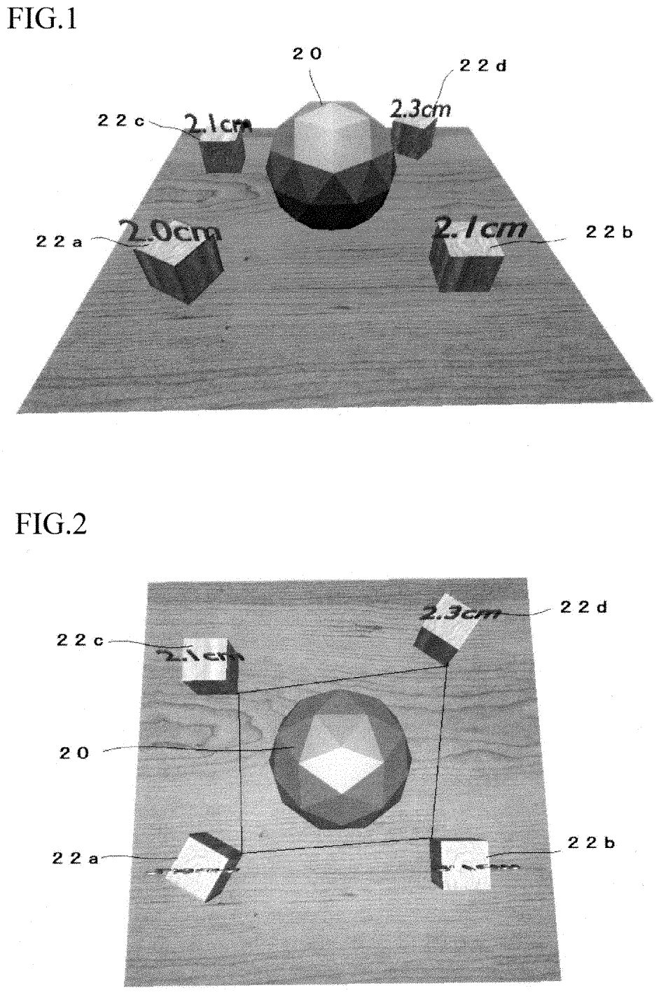

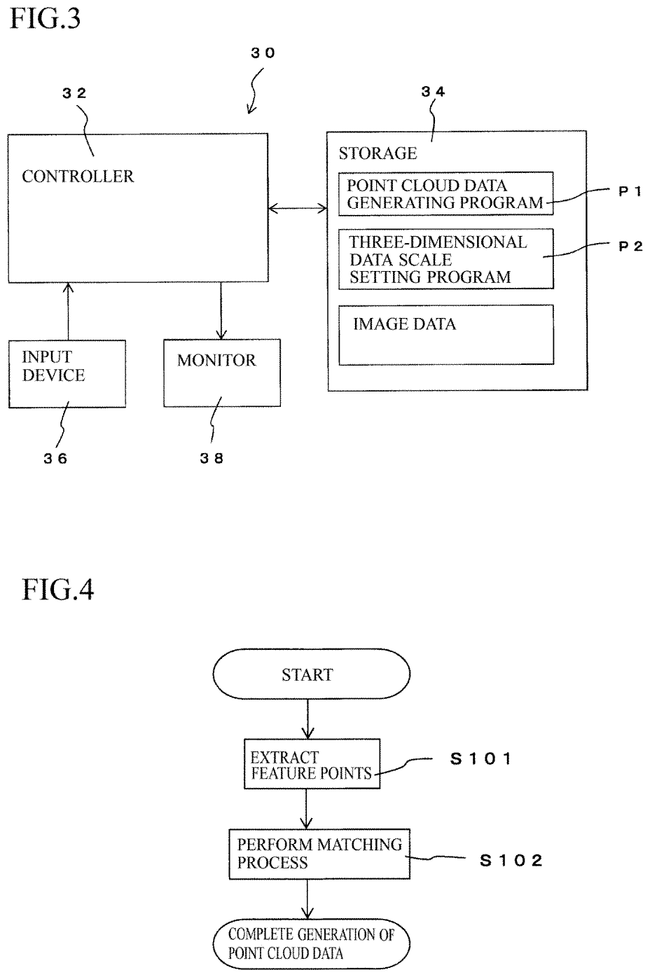

First, a method of photographing a measurement target will be described. FIG. 1 is a perspective view illustrating an arranged state of a measurement target and reference objects. FIG. 2 is a plane view illustrating the arranged state of the measurement target and the reference objects.

A measurement target 20 can be any object, but FIGS. 1 and 2 show a polyhedral object as an example.

A worker sets up a plurality of reference objects 22a to 22d around the measurement target 20 so as to surround the measurement target 20. In the example in FIGS. 1 and 2, cubic reference objects 22a to 22d are set up at four positions around the measurement target 20. Thus, in terms of point cloud data, the measurement target 20 is disposed in the area surround by each of the cubic reference objects 22a to 22d. That is, as shown in FIG. 2, each of the reference objects 22a to 22d is arranged around the measurement target 20 so that the measurement target 20 will be disposed in a quadrangular area formed of straight lines connecting any points on the inside (measurement target side) of the reference objects 22a to 22d.

The length of one side of the cube constituting the reference object is measured in advance. In FIGS. 1 and 2, the length of one side of the reference object 22a on the front left side is 2.0 cm, the length of one side of the reference object 22b on the front right side is 2.1 cm, the length of one side of the reference object 22c on the rear left side is 2.1 cm, and the length of one side of the reference object 22d on the rear right side is 2.3 cm.

However, all of the lengths of one sides of the plurality of reference objects may be the same. In one example, all of the plurality of reference objects may be cubes having sides of 2.0 cm.

The shape of the reference object is not limited to a cubic shape. For example, it may be a rectangular prism shape or may be other shape. Nevertheless, the shape should be one that enables obtaining its dimension and shape from point cloud data by plane estimation or the like.

Then, the worker takes a plurality of photographs of the measurement target 20 from various angles by using a digital camera so that the whole circumference of the measurement target 20 and the plurality of reference objects 22 will be included therein. In addition, photography should be performed so that the photographing ranges will be overlapped one another. The overlapped parts are subjected to a matching process of data, as described later.

Moreover, although a larger number of photographs is more preferable for the purpose of obtaining accurate point cloud data, the worker can determine the number of photographs in consideration of the processing time of a computer, as appropriate.

After photography is completed, the worker inputs data of obtained photographic images to the computer.

In addition, the worker inputs the dimensions and the shapes of the reference objects 22a to 22d (in this embodiment, each reference object is a cube, and thus, the cubic shape and the length of one side of each reference object) to the computer. This operation can be performed at any time before a three-dimensional data scale setting program is executed.

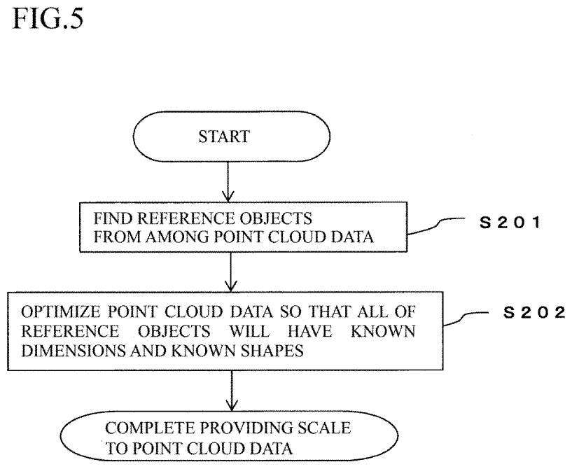

Next, operation in the computer will be described on the basis of FIG. 3. FIG. 3 is a block diagram illustrating a schematic internal configuration of the computer.

A general personal computer can be employed as the computer. A computer 30 includes a controller 32 and a storage 34. The controller 32 includes a central processing unit (CPU or the like) and memories (ROM and RAM) and controls the whole operation of the computer 30 as well as controls execution of a function based on each program stored in the storage 34.

In addition, the computer 30 may be mounted with a graphic board having a GPU.

The storage 34 is composed of a hard disk drive, an SSD, or the like. The storage 34 stores data of obtained photographic images and preliminarily stores a point cloud data generating program P1 and a three-dimensional data scale setting program P2.

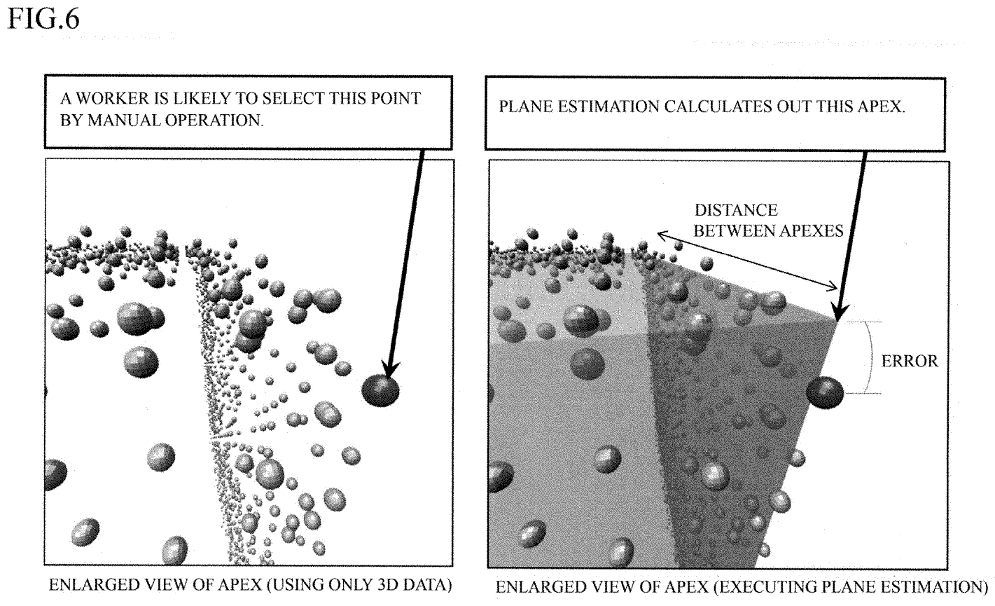

The point cloud data generating program P1 can use a publicly known program. The point cloud data generating program P1 executes an operation as shown in FIG. 4. The point cloud data generating program P1 described herein may be integrated with the three-dimensional data scale setting program P2, which will be described later, into one program.

The computer 30 also includes an input device 36 composed of a mouse, a keyboard, and so on, and a monitor 38 for displaying point cloud data that is generated by the point cloud data generating program P1.

Next, an overview of the operation of the point cloud data generating program P1 will be described on the basis of FIG. 4.

After execution of the point cloud data generating program is started, the point cloud data generating program extracts a plurality of feature points from the plurality of pieces of input image data (S101). A lot of feature points are extracted from parts that are different from other parts in color or shape.

Then, the point cloud data generating program executes a matching process for matching features among the plurality of pieces of image data (S102). The matching process results in generation of point cloud data from the plurality of pieces of image data.

The point cloud data generating program may generate point cloud data so that the point cloud data will have relatively correct positions, by a matrix operation using camera parameters or the like that are input, before the matching process is performed.

Note that pieces of software for generating point cloud data from image data, called “structure from motion (SfM)” and “multi-view stereo (MVS),” are known as existing point cloud data generating programs.

After the point cloud data is generated, the three-dimensional data scale setting program P2 is executed.

As described above, prior to execution of the three-dimensional data scale setting program, the worker performs an operation of inputting the dimensions and the shapes of the reference objects, to the computer.

In the example seen from the viewpoint shown in FIG. 1, the worker inputs that all of the reference objects are cubes and inputs numerical values as follows: The length of one side of the reference object on the front left side is 2.0 cm, the length of one side of the reference object on the front right side is 2.1 cm, the length of one side of the reference object on the rear left side is 2.1 cm, and the length of one side of the reference object on the rear right side is 2.3 cm.

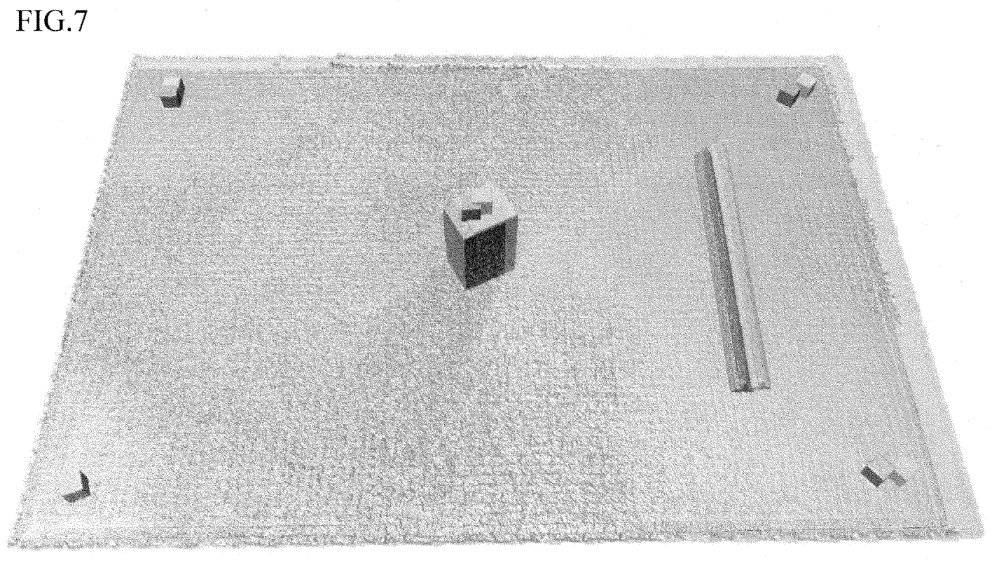

The operation of the three-dimensional data scale setting program will be described on the basis of FIG. 5.

The three-dimensional data scale setting program first executes a function of finding the reference objects from among the point cloud data (step S201).

The dimensions and the shapes of the reference objects are already input by the worker, as described above, and therefore, in this embodiment, the function of finding the reference objects from among the point cloud data is to find a cube with a side of 2.0, 2.1, or 2.3 cm. At this time (at the time of finding the reference objects from among the point cloud data), due to the point cloud data still not having an accurate scale, an object that is presumed to be the reference object may not be a cube having a value that is exactly the input value. For example, the object may be 2.0 cm in one side while being 2.1 cm in other side or may have a trapezoidal shape at a surface of the cube, instead of a square shape.

In view of this, the three-dimensional data scale setting program functions to find the reference objects from among the point cloud data by recognizing an object with a side having a length within an error range, in the point cloud data, as the reference object (step S201). The error range is a predetermined certain error range based on the dimension and the shape of the reference object that are input beforehand (in this embodiment, the value of the length of one side of the cube).

In one example in which the reference object is a cube, an object with a side having a length of less than plus or minus 5 to 10% of the input length of the actual side, in the point cloud data, is recognized as the reference object.

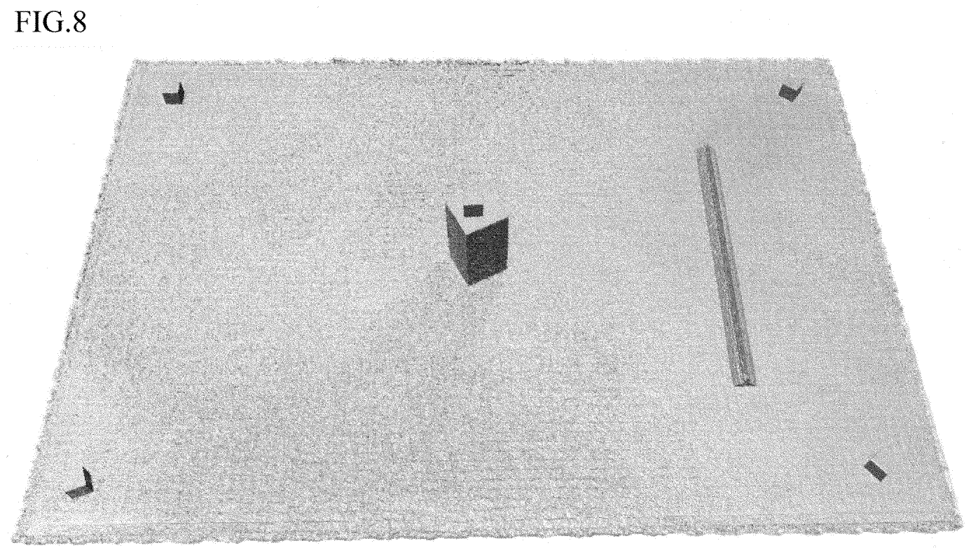

The function of finding the reference objects from among the point cloud data, of the three-dimensional data scale setting program, is implemented by automatically detecting an apex (corner) of the cube of the reference object in plane estimation, as shown in FIG. 6. FIG. 6 illustrates a schematic explanatory diagram of a plane estimation function, and the plane estimation function is provided as one of functions of the three-dimensional data scale setting program. In determining an apex of a cube without using the plane estimation function, a worker is unlikely to determine a correct apex of a cube by relying on visual observation on the monitor 38, as shown by the left drawing in FIG. 6.

The plane estimation function, which is a publicly known technique, is utilized to calculate three adjacent planes of a reference object from a lot of pieces of point cloud data, in the three-dimensional data scale setting program.

The plane estimation function of this embodiment estimates three flat planes in which each point of point cloud data is disposed, as shown by the right drawing in FIG. 6. Accurate estimation of the three planes provides a point of intersection of the three planes as a correct apex. The plane estimation function sets a straight line connecting apexes as one side of a reference object. As described later, the point cloud data is then optimized so that the distance of this straight line will be the length of the side of the reference object, which is input beforehand.

Thereafter, the three-dimensional data scale setting program executes a function of optimizing the point cloud data so that all of the reference objects found from among the point cloud data will have the dimensions and the shapes that are input beforehand (step S202).

Specifically, the function of optimizing the point cloud data, of the three-dimensional data scale setting program, performs expanding and contracting, and/or twisting, of the point cloud data so that all of the found reference objects will have the same scales as actual scales. A specific example of the function of expanding, contracting, and/or twisting the point cloud data includes an affine transformation. An affine transformation is a publicly known method and causes a figure to be enlarged, reduced, rotated, moved in parallel, or sheared in computer graphics. Thus, the function of optimizing the point cloud data, of the three-dimensional data scale setting program, can use and execute an affine transformation.

Specifically, in the case of the reference objects as described in this embodiment shown in FIG. 1, the whole point cloud data is expanded and contracted and, as necessary, is further subjected to twisting, so that the reference object on the front left side will be a cube with a side of 2.0 cm, the reference object on the front right side will be a cube with a side of 2.1 cm, the reference object on the rear left side will be a cube with a side of 2.1 cm, and the reference object on the rear right side will be a cube with a side of 2.3 cm. This provides an accurate scale to the whole three-dimensional space composed of the point cloud data.

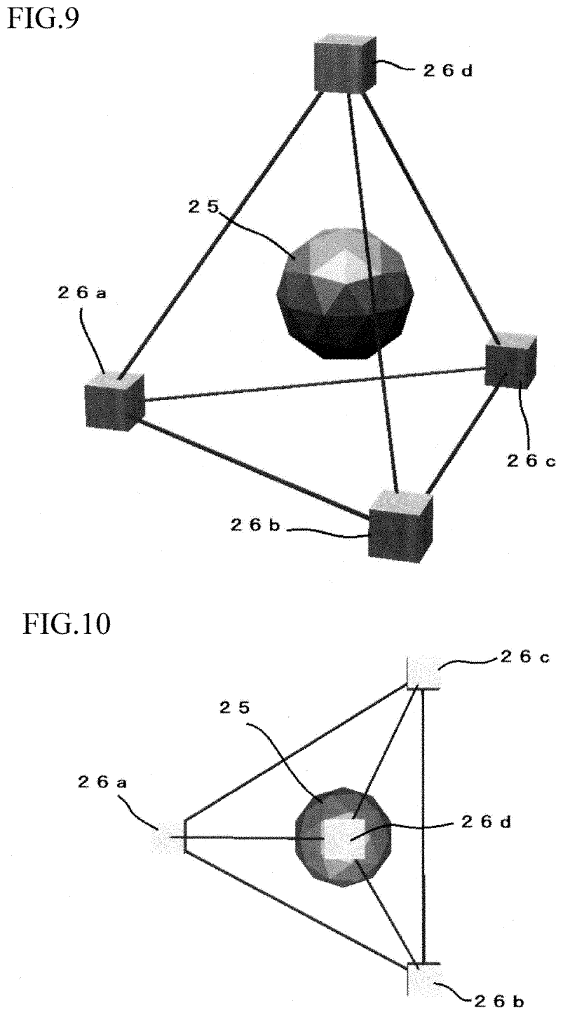

An example of setting scales to certain reference objects in point cloud data is shown in the drawing of FIG. 7.

In the example in FIG. 7, cubic reference objects are arranged at four surrounding positions, and a rectangular prism-shaped object at the center and an elongated bar-shaped object on the right side of the rectangular prism-shaped object are measurement targets. The cubic reference objects are arranged at four positions around these measurement targets, and another cubic reference object is disposed on the top of the rectangular prism-shaped measurement target. In short, five reference objects are arranged in this example.

In FIG. 7, a scale is provided only to the reference object on the front left side. That is, an accurate scale is set to only one reference object, and scales are not set to the measurement targets and the other reference objects.

In response to setting a scale to one reference object, the reference object and the three-dimensional space therearound have a correct scale. However, the three-dimensional space distant from the reference object, to which the scale is set, still has an inaccurate scale. The measurement targets and the other reference objects that are still not provided with accurate scales due to this reason, are shown in light colors in FIG. 7. FIG. 7 also illustrates the measurement targets and the other reference objects in dark colors in adjacent to the measurement targets and the other reference objects in light colors. The measurement targets and the other reference objects in dark colors have actual scales and are intentionally shown in FIG. 7 for comparison.

This FIG. 7 shows that, in the state in which a scale is provided only to one reference object, parts distant from this reference object still have a scale far from accurate scale.

From this point of view, the three-dimensional data scale setting program sets the preliminarily known respective scales (lengths of the sides that are input beforehand) to all of the reference objects in the point cloud data, at the same time. In other words, the three-dimensional data scale setting program executes an operation of optimizing the three-dimensional space so that the respective sides of the reference objects will have the lengths that are input beforehand, at the same time.

Details of optimization of the three-dimensional space are as follows: The point cloud data that is generated by the point cloud data generating program originally does not have a scale and is obtained only by merging and plotting respective positions of photographed points.

For this reason, in such point cloud data, an operation of setting scales in a virtual space of point cloud data is executed so that, for example, sides of all (five) reference objects will have the lengths that are preliminarily known, as shown in FIG. 7.

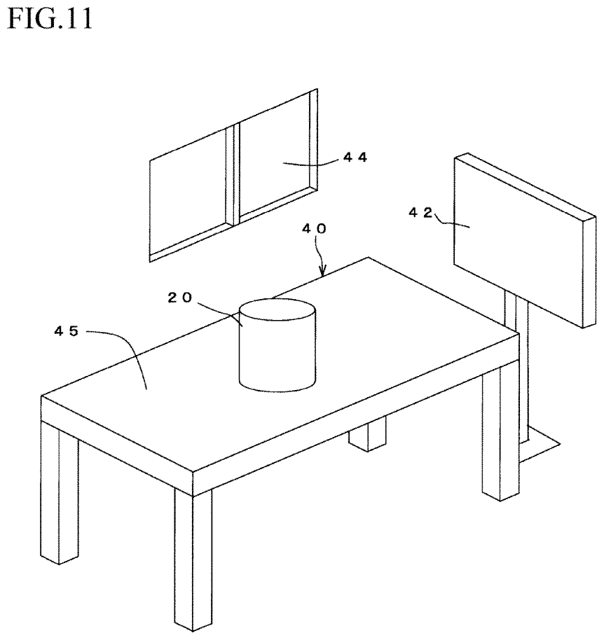

The three-dimensional space is thus optimized so that the sides of the reference objects will have the lengths that are preliminarily known. As a result, as shown in FIG. 8, the measurement targets and the other reference objects in light colors and the measurement targets and the other reference objects in dark colors coincide with each other, and an accurate scale is provided to the point cloud data.

In the example in FIGS. 7 and 8, the reference object (which is referred to as an “upper reference object” in the claims) is disposed also on the top of the measurement target. This provides an accurate scale also in the height direction of the measurement target.

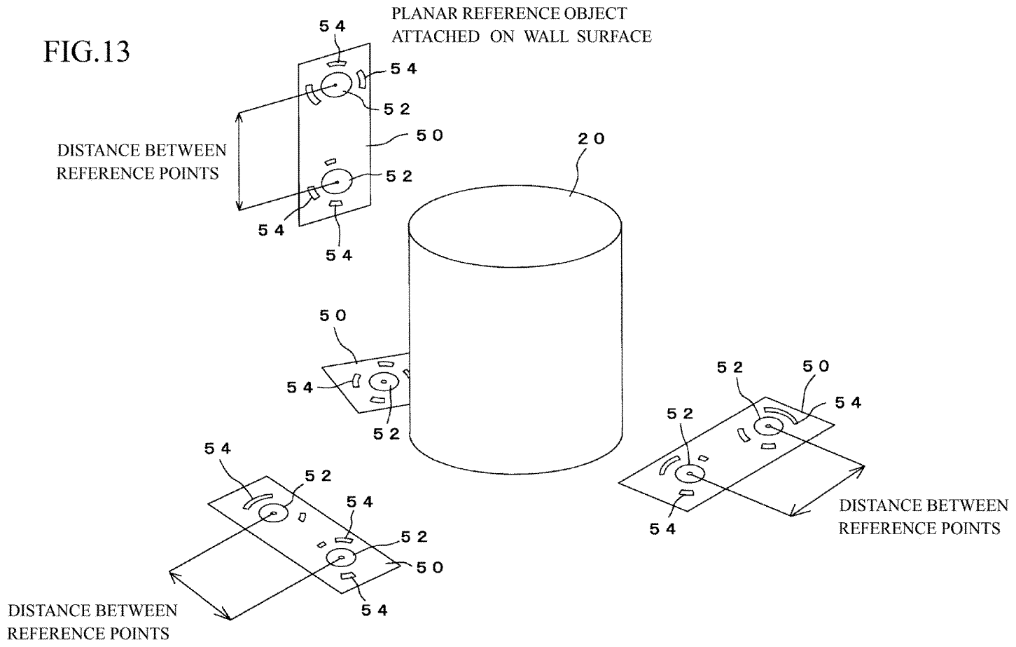

An embodiment of such a reference object disposed on an upper side of a measurement target will be described on the basis of FIGS. 9 and 10.

In FIGS. 9 and 10, with respect to a polyhedral measurement target 25, four cubic reference objects 26a, 26b, 26c, and 26d are arranged so as to surround the whole polyhedral measurement target 25.

The four cubic reference objects 26a, 26b, 26c, and 26d shown in FIGS. 9 and 10 are three-dimensionally arranged in such a manner as to form a tetrahedron, and the measurement target 25 is positioned at approximately the center of the tetrahedron.

Among the reference objects forming the tetrahedron, the reference objects 26a, 26b, and 26c are arranged below the measurement target 25, and the reference object 26d is arranged over the reference object 25.

In this manner, among a plurality of reference objects arranged around a measurement target, some are arranged in or below the plane in which the measurement target is set up (in the same plane as the plane in which the measurement target is set up or a plane below this plane), the other one or more reference objects are arranged over the measurement target, whereby the whole measurement target is positioned in the space having each reference object as an apex. This enables providing an accurate scale to the height direction as well as the longitudinal direction and the width direction of the measurement target.

Although FIGS. 9 and 10 illustrate the measurement target 25 and the upper side reference object 26d in the state of floating in the space, in actual cases, stands are set up, and they are placed on the stands.

As in each embodiment described above, a plurality of reference objects to be arranged around a measurement target may be set up at any positions and at any angles on the condition that they can surround the measurement target in the space they form.

Normally, in order to provide an accurate scale of an orthogonal coordinate system to point cloud data, it is necessary to set up a plurality of reference objects in a completely horizontal plane at angles corresponding to the X-axis, the Y-axis, and the Z-axis of the orthogonal coordinate system and to accurately measure distances between the reference objects. On the other hand, in the present invention, reference objects also can be set up in any arrangement, whereby an accurate scale can be provided to three-dimensional data without requiring time and labor.

### Second Embodiment

In the embodiment described above, reference objects having known dimensions and shapes are arranged around a measurement target, and point cloud data is obtained. In the embodiment described below, in the state in which structures having known dimensions and shapes are already provided around a measurement target, these structures are used as reference objects, instead of setting up reference objects around the measurement target.

FIG. 11 shows an example in which structures are provided around a measurement target.

Herein, a measurement target 20 is placed on a table 40 in a room. The room is provided with a monitor 42, which can be used for a television, a computer, or the like, and a window 44 on a wall surface.

A top board 45 of the table 40 is rectangular, and in the state in which the length of its side is measured, it can be used as a reference in the same plane as the plane in which the measurement target 20 is set up.

The monitor 42 is rectangular in the front view and is disposed on an upper side of the top board 45 of the table 40. In the state in which the length of the side of the monitor 42 is measured, the monitor 42 can be used as a reference on an upper side of the measurement target 20.

Also, the window 44 has a rectangular shape at the whole window frame in the front view and is disposed on the upper side of the top board 45 of the table 40. In the state in which the length of the side of the window 44 is measured, the window 44 can be used as a reference on the upper side of the measurement target 20.

Moreover, a fitting is preferably disposed also on a front side in the perpendicular direction relative to the paper surface of FIG. 11. The combination of the fitting on the front side in the perpendicular direction of the paper surface, the table 40, the monitor 42, and the window 44 can be used as reference objects arranged around the measurement target.

These structures can be any objects that are disposed so as to surround the measurement target 20 and that have dimensions and shapes being able to be known.

For example, the fittings can be posters and calendars hung on wall surfaces, patterns on wall surfaces, shelves, etc.

In this embodiment, a worker takes a plurality of photographs of the measurement target from various angles by using a digital camera so that the whole circumference of the measurement target 20 and the plurality of structures 40, 42, and 44 will be included therein. In addition, photography should be performed so that the photographing ranges will be overlapped one another. The data of obtained photographic images are input to the computer, and point cloud data is generated by the point cloud data generating program. The overlapped parts are subjected to the matching process of data by the computer, whereby point cloud data is generated.

The worker inputs the shapes and the lengths of one sides of the table 40, the monitor 42, and the window 44 to the computer.

Then, the three-dimensional data scale setting program executes the function of finding the structures from among the point cloud data.

The dimensions and the shapes of the structures are already input by the worker, as described above, and the structures are found from among the point cloud data based on the input data.

As in the case of the above-described embodiment, the three-dimensional data scale setting program functions to find the structures from among the point cloud data by recognizing an object with a dimension and a shape within error ranges, in the point cloud data, as the structure. The error ranges are predetermined certain error ranges based on the preliminarily input dimension and shape of the structure.

The function of finding the structures from among the point cloud data, of the three-dimensional data scale setting program, may employ the plane estimation function of automatically detecting an apex (corner) of a cube of a reference object in plane estimation, as in the case of the above-described embodiment.

Thereafter, the three-dimensional data scale setting program executes the function of optimizing the point cloud data so that all of the structures found from among the point cloud data will have the dimensions and the shapes that are input beforehand. This optimization function executes expansion and contraction, and as necessary, executes twisting, of the point cloud data, with the use of an affine transformation, as in the case of the above-described embodiment.

In this manner, using the structures existing around the measurement target as references enables providing an accurate scale to the whole three-dimensional space composed of the point cloud data, without having to set up reference objects.

The structures are not limited to indoor objects, as shown in FIG. 11. For outdoor operation, structures such as buildings and concrete block walls, which have dimensions being able to be known and are disposed around a measurement target, can be used as reference objects.

### Third Embodiment

Next, an embodiment using planar reference objects as reference objects will be described. Note that constituent elements that are the same as those in the above-described embodiments are denoted by the same reference symbols and descriptions thereof may be omitted.

This embodiment employs planar reference objects, as shown in FIG. 12. FIG. 12 illustrates three planar reference objects 50. The planar reference object 50 is made of, for example, a paper sheet or a plastic plate, and has a thin rectangular shape, and two black circles having a white circle at the center are formed at a predetermined distance from each other. The white circle at the center of the black circle is a reference point. Hereinafter, the black circle having the reference point at the center will be described by referring it to as a “marker 52.”

The distance between the reference points (distance between the white circles) of the two markers 52 is set beforehand, in preparing the planar reference object 50. In one example, the distance between the reference points may be set to 10 cm or the like.

A plurality of circular arc-shaped figures are formed around the marker 52 in the planar reference object shown in FIG. 12. This is intended to enable recognizing both the marker and a unique number of the reference object. Hereinafter, the circular arc-shaped figure is referred to as an “identification part 54.”

If there is no identification part 54, the marker 52 is merely a black circle, and it may be difficult for the three-dimensional data scale setting program to recognize the white circle at the center of the marker 52, as a reference point. For example, in a case in which there is another circular object (e.g., a tire of a vehicle), this object may be mistakenly recognized as a marker.

In consideration of this, the circular arc-shaped identification parts 54 are additionally arranged around the marker 52, and the three-dimensional data scale setting program is made to recognize the figure including these identification parts 54, as a reference object, in advance. Under these conditions, it is possible to recognize the white circle at the center of the marker 52 as a reference point by identifying the identification parts 54, in point cloud data generated by the point cloud data generating program.

In addition, the identification parts 54 that are arranged around each of the markers 52 have mutually different shapes.

In one example, FIG. 12 shows three examples of the planar reference object 50, and two markers 52 are formed on one planar reference object 50. Also, in one planar reference object 50, the same or different number of identification parts 54 are arranged at two areas, and the identification parts 54 at each of the two areas have mutually different circular arc lengths.

In addition, all of the formed identification parts 54 are different between one planar reference object 50 and other planar reference object 50.

That is, the shapes of the identification parts 54 formed to the planar reference object 50 are all different, whereby the markers 52 can be individually identified.

In more detail, in the state in which a plurality of planar reference objects 50 are arranged around a measurement target, the three-dimensional data scale setting program executes the optimization function (affine transformation) of point cloud data so that a distance between reference points in one planar reference object 50 will be a distance that is input beforehand. At this time, the three-dimensional data scale setting program may not be able to distinguish which reference points should be connected to each other among the plurality of reference points, in order to set the preliminarily input distance.

From this point of view, in one example, in the planar reference object 50 on the uppermost side in FIG. 12, it is assumed that an identification number of the left marker 52 is set to 1 (which is referred to as a “marker 1”), an identification number of the right marker 52 is set to 2 (which is referred to as a “marker 2”), and a straight line connecting the reference points of the markers 1 and 2 is set to 10 cm. This enables the three-dimensional data scale setting program to distinguish between the markers 1 and 2 by the shapes of the identification parts 54 and to set the distance between the reference points of the markers 1 and 2.

In another example, in the planar reference object 50 at the center in FIG. 12, it is assumed that an identification number of the left marker 52 is set to 3, an identification number of the right marker 52 is set to 4, and a straight line connecting the reference points of the markers 3 and 4 is set to 10 cm. This enables the three-dimensional data scale setting program to distinguish between the markers 3 and 4 by the shapes of the identification parts 54 and to set the distance between the reference points of the markers 3 and 4.

In an embodiment shown in FIG. 13, three planar reference objects 50 are arranged around a measurement target 20.

A worker takes a plurality of photographs of the measurement target from various angles by using a digital camera so that the whole circumference of the measurement target 20 and the plurality of planar reference objects 50 will be included therein. In addition, photography should be performed so that the photographing ranges will be overlapped one another. The data of obtained photographic images are input to the computer, and point cloud data is generated by the point cloud data generating program. The overlapped parts are subjected to the matching process of data by the computer, whereby point cloud data is generated.

The worker makes the computer read the shape of each marker 52 including the identification parts 54 and assigns an identification number to every marker depending on difference of the identification parts 54. Then, the distance between the reference points of the two markers 52 existing on one planar reference object 50 is input. The distance between the reference points is set as a distance between the identification numbers that are set.

Thereafter, the three-dimensional data scale setting program executes the function of finding the planar reference objects 50 from among the point cloud data.

The marker 52 that is formed on the planar reference object is set as a specific figure by using the identification parts 54, and therefore, the three-dimensional data scale setting program is able to recognize both the identification number and the marker 52.

Thereafter, the three-dimensional data scale setting program executes the function of optimizing the point cloud data, with respect to the reference point of each marker that is found from among the point cloud data, so that the distance between the reference points paired on one planar reference object 50 will be a distance that is input beforehand.

In one example, it is assumed that the three-dimensional data scale setting program recognizes markers 52 of identification numbers 1 to 6 and that a worker inputs a distance between reference points of the identification numbers 1 and 2, a distance between reference points of the identification numbers 3 and 4, and a distance between reference points of the identification numbers 5 and 6, in advance. In this case, the three-dimensional data scale setting program optimizes the point cloud data so that the distance between the reference points of the identification numbers 1 and 2, the distance between the reference points of the identification numbers 3 and 4, and the distance between the reference points of the identification numbers 5 and 6 will be respectively the distances that are input. This optimization function executes expansion and contraction, and as necessary, also executes twisting, of the point cloud data, with the use of an affine transformation, as in the case of the above-described embodiments.

In this manner, the planar reference object, which is formed with the two reference points having a known distance therebetween, is used, and the distance between the reference points is input beforehand. Thus, it is not necessary for the program to perform the operation of recognizing apexes of reference objects by plane estimation, whereby processes of the operation of the program can be reduced.

The planar reference object 50 may be attached on a wall surface existing around the measurement target 20, as shown in FIG. 13. This enables providing a scale also in the height direction of the measurement target.

Each of the foregoing embodiments is described by using an example of generating the point cloud data based on the data of a plurality of photographic images taken by a digital camera.

However, the point cloud data of the present invention may be generated based on position data that is obtained by a laser scanner.

1. A three-dimensional data scale setting method being a method for providing a scale to three-dimensional data composed of point cloud data, the method characterized by comprising:
arranging a plurality of reference objects having known dimensions and known shapes, around a measurement target;
inputting to a computer, image data obtained by photographing the measurement target and the plurality of reference objects from various angles with a use of a digital camera, or position data obtained by scanning the measurement target and the plurality of reference objects from various angles with a use of a laser scanner; and
inputting the known dimension and the known shape of each of the reference objects, to the computer,
the computer configured to:
obtain point cloud data containing the measurement target and each of the reference objects, from a plurality of pieces of the image data or a plurality of pieces of the position data;
recognize an object with a dimension and a shape within predetermined error ranges based on the input dimension and the input shape of each of the reference objects, as the reference object, in the point cloud data; and
set a scale of the point cloud data as a whole by expanding and contracting, and/or twisting, the point cloud data, so that each of the recognized reference objects has the input dimension and the input shape.

2. The three-dimensional data scale setting method according to claim 1, characterized in that the reference object is a cube or a rectangular prism.

3. The three-dimensional data scale setting method according to claim 1, characterized in that the number of the reference objects arranged around the measurement target is at least two, and the measurement target is positioned on a straight line connecting the reference objects.

4. The three-dimensional data scale setting method according to claim 1, characterized in that each of the reference objects arranged so as to surround the measurement target is disposed at a position in or below a plane in which the measurement target is set up, and
an upper reference object having a known dimension and a known shape is set up on an upper side of the measurement target.

5. A three-dimensional data scale setting program being a program for providing a scale to three-dimensional data composed of point cloud data, in a computer, the program characterized by making the computer execute:
after point cloud data of a measurement target and each of a plurality of reference objects is obtained from image data or position data, the image data being obtained by photographing the measurement target and the plurality of reference objects from various angles with a use of a digital camera, the position data being obtained by scanning the measurement target and the plurality of reference objects with a use of a laser scanner, the reference objects having known dimensions and known shapes and being arranged around the measurement target,
a function of recognizing an object with a dimension and a shape within predetermined error ranges based on the known dimension and the known shape of each of the reference objects, as the reference object, in the point cloud data; and
a function of setting a scale of the point cloud data as a whole by expanding and contracting, and/or twisting, the point cloud data, so that each of the recognized reference objects has a dimension and a shape that are known.

6. The three-dimensional data scale setting program according to claim 5, characterized in that the reference object is a cube or a rectangular prism.

7. The three-dimensional data scale setting program according to claim 5, characterized in that the number of the reference objects arranged around the measurement target is at least two, and the measurement target is positioned on a straight line connecting the reference objects.

8. The three-dimensional data scale setting program according to claim 5, characterized in that each of the reference objects arranged so as to surround the measurement target is disposed at a position in or below a plane in which the measurement target is set up, and
an upper reference object having a known dimension and a known shape is set up on an upper side of the measurement target.

9. A three-dimensional data scale setting method being a method for providing a scale to three-dimensional data composed of point cloud data, the method characterized by comprising:
inputting to a computer, image data obtained by photographing a measurement target and a plurality of structures from various angles with a use of a digital camera, or position data obtained by scanning the measurement target and the plurality of structures from various angles with a use of a laser scanner, the structures having known dimensions and known shapes and being provided around the measurement target; and
inputting the known dimension and the known shape of each of the structures, to the computer,
the computer configured to:
obtain point cloud data containing the measurement target and each of the structures, from a plurality of pieces of the image data or a plurality of pieces of the position data;
recognize an object with a dimension and a shape within predetermined error ranges based on the input dimension and the input shape of each of the structures, as the structure, in the point cloud data; and
set a scale of the point cloud data as a whole by expanding and contracting, and/or twisting, the point cloud data, so that each of the recognized structures has the input dimension and the input shape.

10. A three-dimensional data scale setting program being a program for providing a scale to three-dimensional data composed of point cloud data, in a computer, the program characterized by making the computer execute:
after point cloud data of a measurement target and each of a plurality of structures is obtained from image data or position data, the image data being obtained by photographing the measurement target and the plurality of structures from various angles with a use of a digital camera, the position data being obtained by scanning the measurement target and the plurality of structures with a use of a laser scanner, the structures having known dimensions and known shapes and being provided around the measurement target,
a function of recognizing an object with a dimension and a shape within predetermined error ranges based on the known dimension and the known shape of each of the structures, as the structure, in the point cloud data; and
a function of setting a scale of the point cloud data as a whole by expanding and contracting, and/or twisting, the point cloud data, so that each of the recognized structures has a dimension and a shape that are known.

11. A three-dimensional data scale setting method being a method for providing a scale to three-dimensional data composed of point cloud data, the method characterized by comprising:
arranging a plurality of planar reference objects around a measurement target, the planar reference object having two reference points that are shown on the same surface and have a known length therebetween;
inputting to a computer, image data obtained by photographing the measurement target and the plurality of planar reference objects from various angles with a use of a digital camera, or position data obtained by scanning the measurement target and the plurality of planar reference objects from various angles with a use of a laser scanner; and
inputting the length between the reference points on each of the planar reference objects, to the computer,
the computer configured to:
obtain point cloud data containing the measurement target and each of the planar reference objects, from a plurality of pieces of the image data or a plurality of pieces of the position data; and
set a scale of the point cloud data as a whole by expanding and contracting, and/or twisting, the point cloud data, so that the length between the reference points shown on each of the planar reference objects in the point cloud data has the input length.

12. A three-dimensional data scale setting program being a program for providing a scale to three-dimensional data composed of point cloud data, in a computer, the program characterized by making the computer execute:
after point cloud data of a measurement target and each of a plurality of planar reference objects is obtained from image data or position data, the image data being obtained by photographing the measurement target and the plurality of planar reference objects from various angles with a use of a digital camera, the position data being obtained by scanning the measurement target and the plurality of planar reference objects with a use of a laser scanner, the planar reference objects being provided around the measurement target, the planar reference objects having two reference points that are shown on the same surface and have a known length therebetween,
a function of setting a scale of the point cloud data as a whole by expanding and contracting, and/or twisting, the point cloud data, so that the length between the reference points shown on each of the planar reference objects in the point cloud data has a length that is known.
